(19) United States
(12) Patent Application Publication
(10) Pub. No.: US 2017/0011614 A1
(43) Pub. Date: Jan. 12, 2017

(54) SYSTEMS AND METHODS LOCATING EYEGLASSES

(71) Applicant: Dafna Ariely, Caesarea (IL)

(72) Inventor: Dafna Ariely, Caesarea (IL)

(21) Appl. No.: 15/173,403

(22) Filed: Jun. 3, 2016

Related U.S. Application Data
(63) Continuation-in-part of application No. 14/362,992, filed on Jun. 5, 2014, now abandoned.

(51) Int. Cl. G08B 21/24; G08B 7/06; G08B 5/22

(52) U.S. Cl. CPC G08B 21/24; G08B 5/22; G08B 7/06

(57) ABSTRACT

The disclosure relates to methods and systems used to locate eyeglasses. Specifically, the disclosure relates to systems of components configured to provide a user with the location of the glasses.

### CROSS REFERENCE TO RELATED APPLICATIONS

This application is a continuation in part of U.S. application Ser. No. 14/362,992 filed Jun. 5, 2014, which is a §371 National Phase Application of PCT/IL2012/050515 filed Dec. 6, 2012, claiming priority from U.S. Provisional application No. 61/567,134 filed Dec. 6, 2011, all which are incorporated herein by reference in their entirety.

### BACKGROUND

The disclosure is directed to methods and systems used to locate eyeglasses. Specifically, the disclosure relates to a system of components configured to provide a user with the location of the glasses.

Few known devices are utilized for finding misplaced items. Some of these known devices are aimed particularly to locate misplaced eyeglasses. Typically, devices for locating misplaced eyeglasses are configured to be installed in a casing unit at a distal end of an eyeglasses arm and are not utilized as ornaments for the eyeglasses. Typically, the casing unit is not usable with generic eyeglasses. Some types of locators are embedded with the glasses frame or with a part of a glasses frame, and are not removable and/or replaceable, and/or require specially designed eyeglasses. Additionally, some of the eyeglasses locators are located and/or designed in a manner that may harm the glasses or the frame and/or their functionality.

Moreover, those embedded locators do not have replaceable power source nor the circuitry to enable interface with mobile communication devices (smartphones)

### SUMMARY

Disclosed, in various embodiments, are methods and systems used to locate eyeglasses. Specifically, the disclosure relates to a system of components configured to provide a user with the location of the glasses.

In an embodiment provided herein is a system for locating eyeglasses comprising: a pair of eyeglasses comprising a miniature locator having: a transceiver; a power source; an alarm module; and a microprocessor in communication with the transceiver, the power source and the alarm module the microprocessor, transceiver, power source and alarm module located on a single printed circuit board removably embedded within a temple arm of the eyeglasses; and a mobile communication device comprising: a display; a transceiver; and a processor, the processor being in communication with a non-volatile memory having a processor-readable media thereon with an executable set of instructions configured to: receive a signal transmitted from the transceiver; based on the strength of the transmitted signal, provide a visual indication on the display; and using the mobile communication transceiver, optionally sending a signal to the eyeglasses transceiver.

### BRIEF DESCRIPTION OF THE FIGURES

Several embodiments of the invention will now be more fully described, by way of example, with reference to the drawings, of which:

FIG. 1, is a schematic illustration of a system for locating an item according to embodiments of the present invention;

FIGS. 2A, 2B, and 2C are schematic illustrations of devices for locating an item according to embodiments of the present invention, which may be attached to a temple arm of eyeglasses, camouflaged as an ornament or embedded within the eyeglasses arm;

FIG. 3, illustrates a cut-away of an embodiment of the locator housing; and

FIG. 4, illustrates an embodiment of the locator components on a single rigid-flex-rigid PCB.

### DETAILED DESCRIPTION

Provided herein are embodiments of methods and systems used to locate eyeglasses. In other embodiments, provided herein are embodiments of systems of components configured to provide a user with an indication of the location of the eyeglasses.

Embodiments of the present invention may provide a user with a convenient search and locating system and device for finding a misplaced small item such as eyeglasses, wherein a transceiver operably coupled to the item (e.g., eyeglasses) may be designed as decoration such as, for example, jewelry. In some embodiments, the miniature locator may be designed and/or located not to adversely affect the design and functionality of the glasses and/or glasses frame (in other words, not being visible when the eyeglasses are worn by a user. The transceivers (the eyeglasses' and the mobile communication device's) may be advance technology transceivers and therefore may have light weight and small size, which may enable, for example, the use of various designs for the receiver casing. The miniature locator housing may be designed as a jewelry complimenting the eyeglasses design and function and/or camouflaged in the inner side of the frame.

In an embodiment, the term “miniature” refers to the size of the electronic component (e.g., the locator), regardless of its function or performance; of such size that it can be easily transported and stored in a minimum of space and having an overall length of less than about 4 centimeters and a width of less than about 1 cm and depth than about 0.6 cm.

Moreover the systems describe herein may further comprise a mobile communication device equipped with a display configured to provide a visual indication of the location of the eyeglasses, which is based on the strength of the signal received from the eyeglasses transceiver and received by the mobile communication device's transceiver.

Accordingly and in an embodiment, provided herein is a system for locating eyeglasses comprising: a pair of eyeglasses comprising; a transceiver; a power source; an alarm module; and a microprocessor in communication with the transceiver, the power source and the alarm module the microprocessor, transceiver, power source and alarm module located on a single printed circuit board removably embedded within a temple arm of the eyeglasses; and a mobile communication device comprising: a display; a transceiver; and a processor, the processor being in communication with a non-volatile memory having a processor-readable media thereon with an executable set of instructions configured to: receive a signal transmitted from the transceiver; based on the strength of the transmitted signal, provide a visual indication on the display; and using the mobile communication transceiver, optionally sending a signal to the eyeglasses transceiver.

Moreover, the printed circuit board (PCB) on which the transceiver, power source, alarm module and microprocessor are incorporated, is a rigid-flexible-rigid PCB. As used herein, the rigid flex rigid circuit board includes in an embodiment a combination of rigid circuit portions and flexible circuits portion, that form a single, electrically interconnected structure. The rigid circuit boards incorporates two printed circuit boards (PCBs) that act as external layers, making the rigid circuit board a rigid structure with an inner flexible layer. In the flexible circuits, the two external PCBs included in the rigid circuit boards are cut away leaving the inner flexible layer as a flexible structure.

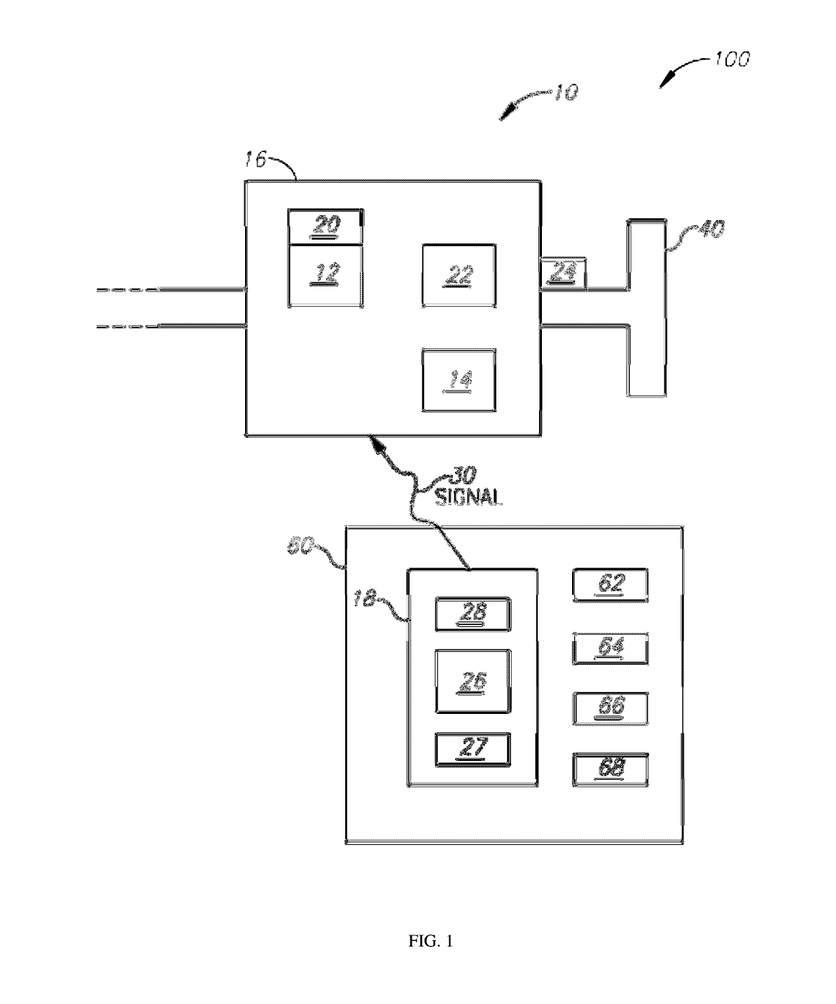

Reference is now made to FIG. 1, which is a schematic illustration of a system 100 for locating eyeglasses according to embodiments of the present invention. System 100 may include a locator device 10 and a transmitter 18. Locator device 10 may include a receiver 12 (or may be a single transceiver), an alarm module 14, a housing 16, which may house receiver 12 and/or alarm module 14, an antenna 20, a power source 22 and a connector 24 to attach device 10 to an item 40, for example eyeglasses.

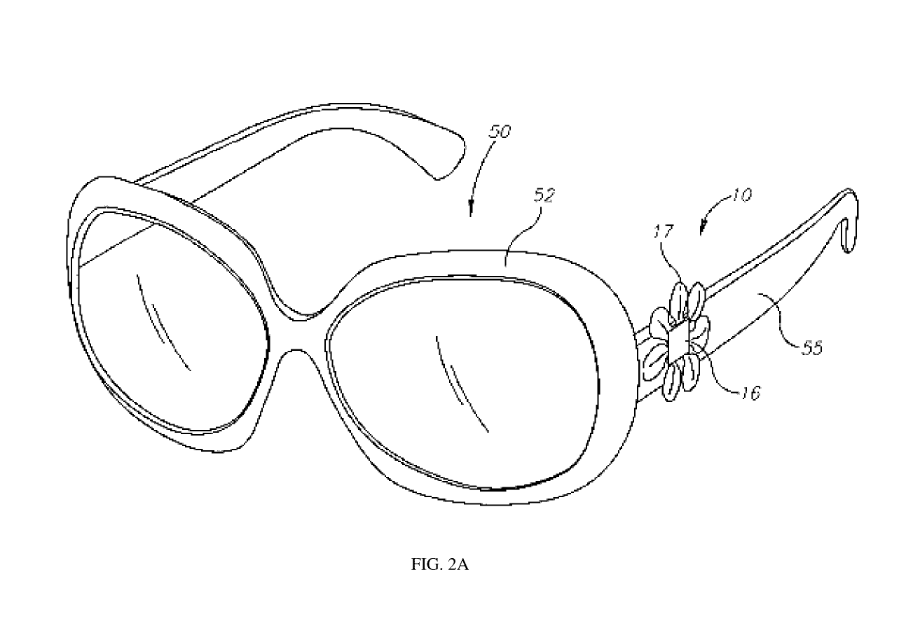

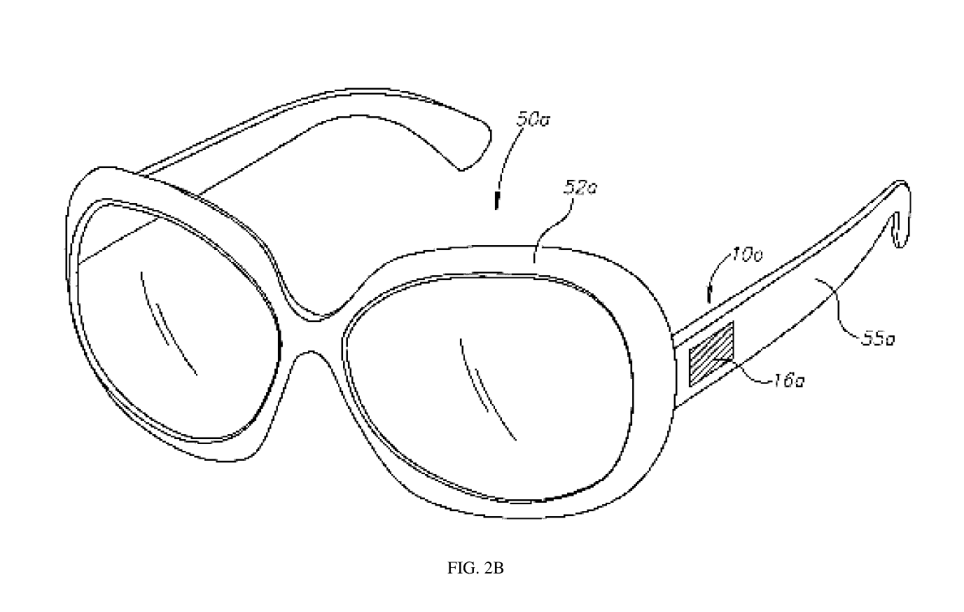

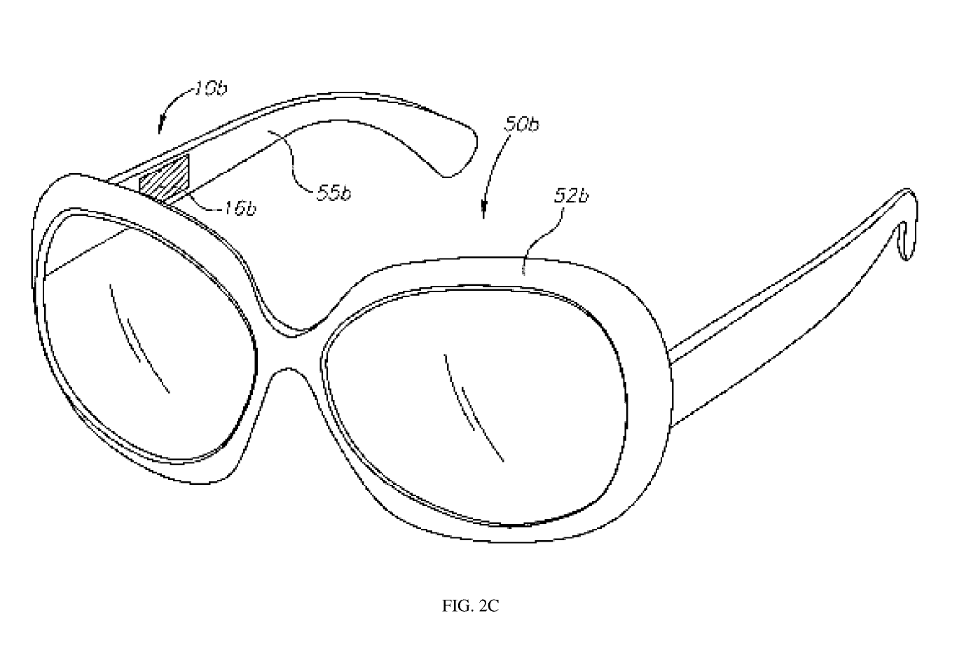

In some embodiments, housing 16 may be designed as ornamentation and/or include an ornament with the eyeglass. Typically, As shown in FIGS. 2A, 2B or 2C, the miniature locator housing 16 or 16b may be designed to be camouflaged in the internal side of the glasses temple arms, as an ornament or embedded within the eyeglasses arm (see housing 16a in FIG. 2B or 16b in FIG. 2C). In other embodiments, housing 16 is entirely invisible when the glasses are worn. Typically, housing 16 or 16a may be located on or within one of the glasses temple arms (in the internal or external side), for example at the region located against the temple of the wearer, when the eyeglasses are worn, as shown, for example, in FIGS. 2A, 2B and 2C. Housing 16 may be made at various shapes and/or sizes, for example so as to enable housing of the modules of device 10. The possibility to design housing 16 in various sizes may be enabled due to a relative small size and/or light weight of receiver 12, which can be a transceiver, eliminating the need for transmitter 18.

Housing 16 may be designed and/or include an ornament (for example, as shown in FIG. 2A) in various styles such as, for example, eyeglasses jewelry. Thus, for example, housing 16 may be designed and/or include an ornament (shown in FIG. 2A) to disguise device 10 as an ornament with an eyeglasses. The design of housing 16 and/or the included ornament may enable device 10 to be complementary with the eyeglass and thus, for example, may integrate with and/or not interfere with eyeglasses design and function. The variety of design possibilities that may be enabled, for example, due to the small size and/or weight of receiver 12, may include variety of styles such as, for example, from relatively small and unnoticeable design, to relatively big and fashionable design.

Transmitter 18, which may be a transceiver 18 may be included, for example, in a in a mobile communication device such as, for example, a tablet computer, a cellular phone or a smartphone device 60. Transceiver 18 may include, for example, a signal generator 26, a power source 27 and an antenna 28. Transceiver 18 may be included, for example, in a mobile device 60 such as, for example, a dedicated remote with a display, cellular phone, smartphone, tablet computer, WI-FI module with a display, GSM module, Bluetooth module and/or any other transmitter and/or in any other communication device or other device that can send a signal, using, for example, low energy short-range communication. Transceiver 18 may be synchronized with transceiver 12, for example to generate and/or transmit a pre-selected signal 30, for example by signal generator 26. Pre-selected signal may be received by transceiver 12, for example once transceiver 12 is within a reception range from transceiver 18. Transceiver 12 may identify whether signal 30 is a pre-selected signal. Once receiving pre-selected signal 30, transceiver 12 may optionally actuate alarm module 14 to produce a voice and/or visual alarm, for example in order to draw a user's attention to the location of device 10 and thus, for example, to the location of eyeglasses 40. In some embodiments of the present invention, transceiver 18 may be synchronized with additional transceivers 12.

As mentioned above, in some embodiments of the present application, transceiver 18 may be included in a smartphone or tablet or other mobile device 60 having a display, which may further include a display 62, memory 64, a processor 66 and a user interface 68. Memory 64 may include an article such as a computer or processor readable non-transitory (volatile) storage medium, such as for example a memory card, a disk drive, or a USB flash memory encoding, including or storing instructions, e.g., computer-executable instructions, such as, for example, application/software items downloaded from an application server. When executed by a processor or controller such as processor 66, the instructions stored and/or included in memory 64 may cause the processor or controller to carry out methods disclosed herein.

Application/software items for the smartphone/tablet, according to embodiments of the present invention, may be downloaded and stored in memory 64 automatically or following a user command entered by user interface 68. According to embodiments of the present invention, transceiver 18 may transmit a pre-selected signal 30, for example by signal generator 26. Pre-selected signal may be received by transceiver 12, for example once transceiver 12 is within a reception range from transceiver 18. Transceiver 12 may identify whether signal 30 is a pre-selected signal. Once receiving pre-selected signal 30, transceiver 12 may optionally actuate alarm module 14 to produce a voice and/or visual alarm, for example in order to draw a user's attention to the location of device 10 and thus, for example, to the location of item 40. Additionally or alternatively, transceiver 12 may send a feedback signal back to transceiver 18. Mobile device 60 may estimate the distance and/or may sense changes in distance from locator device 10, and/or may sense when mobile device 60 is taken further away from or towards locator device 10, for example based on the strength of the feedback signal received from locator device 10. According to the changes in distance from locator device 10, mobile device 60 may generate vocal and/or visual indications and/or notifications to notify a user of the changes in distance from locator device 10. Thus, a user may identify were he should go in order to find, for example, eyeglasses 40.

Reference is now made to FIGS. 2A and 2B, which are schematic illustrations of device 10 or 10a for locating an item according to embodiments of the present invention, described in detail above, which may be attached to an eyeglasses temple arm 55 or 55a of eyeglasses 50 or 50a. In FIG. 2A, housing 16 may include a decorative ornament shape and/or may carry a decorative ornament 17 such as, for example a flower shaped ornament or any other suitable shape. As discussed above, housing 16 may typically be secured to temple arm 55. Furthermore, housing 16 may be configured for easy and simple removal from the arm 55.

According to embodiments of the present invention, housing 16 may be operably coupled to arm 55, so as to minimize the disturbance that may be caused to a field of view of a potential wearer of glasses 50 and or to the wearing convenience and/or proper fit of glasses 55. As shown in FIG. 2A, for example in order to achieve minimal disturbance by housing 16, a typical location for coupling housing 16 to arm 55 may be in a region of arm 55 between a location on arm 55 to be supported by an ear of a wearer and a connection of arm 55 with lens frame 52, for example relatively close to a lens frame 52 of glasses 50. Additionally as shown in FIG. 2A, another location for coupling housing 16 may be in an internal side of arm 55, e.g. the side facing the wearer when the glasses are worn.

As shown in FIG. 2B and 2C, housing 16a or 16b, which may be similar, function similarly and/or include similar elements to housing 16, may be embedded within arm 55a/b of eyeglasses 50a/b. As shown in FIG. 2B, for example in order to achieve minimal disturbance by housing 16a and/or, for example, minimal disturbance to communications with transceiver 12 included in housing 16a, a typical location for embedding housing 16a within arm 55a may be in a region of arm 55a between a location in arm 55a to be supported by an ear of a wearer and a connection of arm 55a with lens frame 52a, for example relatively close to a lens frame 52a of glasses 50a. Additionally as shown in FIG. 2B, another location for embedding housing 16a may be in an internal side of arm 55a, e.g. the side facing the wearer when the glasses are worn.

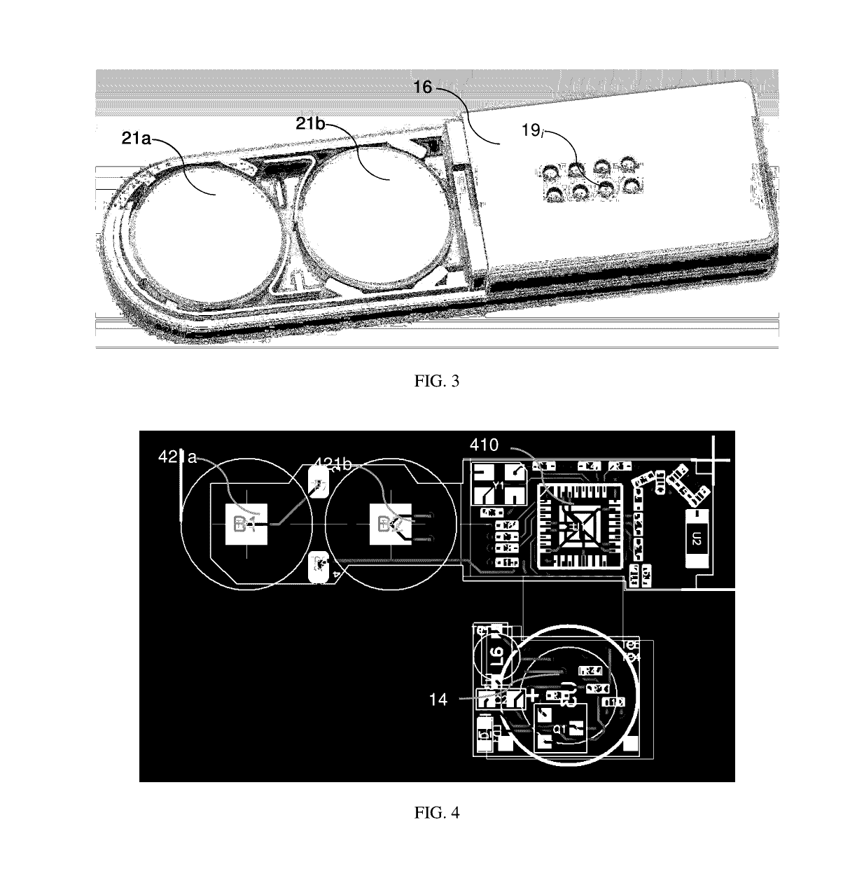

Turning now to FIG. 3, illustrating a cut away of housing 16 defining plurality of orifices 19ᵢ forming an array therein allowing audible signals to be transmitted by alarm module 14 (not shown). As illustrated, a pair of batteries 21a, 21b are disposed along the longitudinal axis of housing 16.

Turning now to FIG. 4, illustrating the rigid flex PCB, wherein rigid portion A, comprises, for example, battery contacts 421a, 421b and microprocessor 410, while second rigid portion B, comprises alarm module 14 with flexible portion C not shown comprises traces. In another embodiment, the rigid flex configuration enables housing 16 to occupy an area of no more than about 4 cm², with a thickness of no more than about 0.6 cm, bringing the volume occupied by the miniature locator to no more than about 2.4 cm³. Housing 16 may further comprises a slidable cover 17 (not shown, see e.g., FIG. 3) configured to allow selectibly removing and replacing batteries 21a and/or 21b. As further illustrated, transceiver 12 and microprocessor 410 are consolidated into a single component (shown as microprocessor 410).

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

All ranges disclosed herein are inclusive of the endpoints, and the endpoints are independently combinable with each other. “Combination” is inclusive of blends, mixtures, alloys, reaction products, and the like. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the transceiver(s) includes one or more transceiver). Reference throughout the specification to “one embodiment”, “another embodiment”, “an embodiment”, and so forth, when present, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

All ranges disclosed herein are inclusive of the endpoints, and the endpoints are independently combinable with each other. Furthermore, the terms “first,” “second,” and the like, herein do not denote any order, quantity, or importance, but rather are used to denote one element from another.

Likewise, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

What is claimed:

1. A system for locating eyeglasses comprising:
a. a pair of eyeglasses comprising a miniature locator having;
i. a transceiver;
ii. a power source;
iii. an alarm module; and
iv. a microprocessor in communication with the transceiver, the power source and the alarm module
the microprocessor, transceiver, power source and alarm module located on a single printed circuit board removably embedded within a temple arm of the eyeglasses; and
b. a mobile communication device comprising a miniature locator having:
i. a display;
ii. a transceiver; and
iii. a processor, the processor being in communication with a non-volatile memory having a processor-readable media thereon with an executable set of instructions configured to:
1. receive a signal transmitted from the transceiver;
2. based on the strength of the transmitted signal, provide a visual indication on the display; and
3. using the mobile communication transceiver, optionally sending a signal to the eyeglasses transceiver.

2. The system of claim 1, wherein upon receiving a signal from the mobile communication transceiver, the alarm module is configured to emit an audible signal.

3. The system of claim 2, wherein the miniature locator having microprocessor, transceiver, power source and alarm module located on a single printed circuit board are encased in a housing removably embedded within a temple arm of the eyeglasses.

4. The system of claim 3, wherein the transceiver and processor are consolidated to a single component.

5. The system of claim 3, wherein the printed circuit board (PCB) is a rigid-flexible-rigid PCB.

6. The system of claim 4, wherein the mobile communication device is a cellular phone, a smartphone, a tablet computer, a Wi-Fi module, a GSM module, or a Bluetooth module.

7. The system of claim 5, wherein the power source is a pair of batteries.

8. The system of claim 6, wherein the miniature locator has a volume of no more than 0.25 cm³.
